(19) United States
(12) Patent Application Publication
(10) Pub. No.: US 2009/0276730 A1
(43) Pub. Date: Nov. 5, 2009

(54) TECHNIQUES FOR NAVIGATION OF HIERARCHICALLY-PRESENTED DATA

(76) Inventors: ALEXANDRE AYBES, Los Altos, CA (US); Evan Doll, San Francisco, CA (US); Sean Kelly, Cupertino, CA (US); Virgil King, Cupertino, CA (US); Paul Marcos, Los Altos, CA (US); Greg Novick, Cupertino, CA (US); Charles John Pisula, Bethesda, MD (US)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/397,991

(22) Filed: Mar. 4, 2009

Related U.S. Application Data
(60) Provisional application No. 61/033,766, filed on Mar. 4, 2008.

(51) Int. Cl. G06F 3/048

(52) U.S. Cl. 715/825

(57) ABSTRACT

The present disclosure generally relates to providing third party applications a standardized framework for presenting user interface elements for its content. In particular, embodiments may provide application programming interfaces (APIs) to user interface views and user interface control elements. In some embodiments, the APIs may provide user interface views and control elements that can be arranged in a stack, which can allow for efficient transition and navigation between the various views of the third party applications as well as other applications on a device.

The present application claims priority to U.S. Provisional Application No. 61/033,766, filed Mar. 4, 2008, and entitled APPLICATION PROGRAMMING INTERFACES FOR DISPLAYING CONTENT ON A MOBILE COMPUTING DEVICE, which is hereby incorporated by reference.

### BACKGROUND

1. Technical Field

This disclosure generally relates to mobile computing devices. More specifically this disclosure relates to computer-implemented methods and systems for enabling third party applications to display content on a mobile computing device.

2. Description of the Related Technology

Some mobile computing devices offer application programming interfaces (APIs) to third party applications. Such APIs may be important because they can allow third parties to develop applications for these devices.

However, a significant problem with offering APIs is protecting the stability of the device. An ill-structured application can dramatically hurt the performance and stability of a device, especially a mobile computing device. These issues are especially problematic when the third party application is attempting to display and animate sophisticated content on a mobile computing device.

Accordingly, it may be desirable to provide APIs in a mobile computing device that allows for efficient and stable display of content on a mobile computing device.

### BRIEF DESCRIPTION OF THE DRAWINGS

FIG. 1 illustrates a system configured to enable a third party application to place content on a display of a mobile computing device, in accordance with some embodiments of the inventions.

FIG. 2 illustrates a block diagram of the software development kit shown in FIG. 1.

FIG. 3 is a block diagram of a mobile computing device shown in FIG. 1.

FIG. 4 illustrates a high level architecture for the mobile computing device of FIG. 1.

FIG. 5 illustrates the application programming interface runtime module of FIG. 3, and illustrates exemplary interfaces.

FIG. 6 illustrates an example runtime environment for displaying content on the mobile computing device that includes instances of the navigation controller interface and view controller interface of FIG. 5.

FIG. 7 illustrates example content of a third party application that can be displayed on the mobile computing device by the navigation controller interface and view controller interface of FIG. 5.

FIG. 8 is a flow chart illustrating embodiments of exemplary methods for handling a service request received from a third party application to detect movement of a mobile computing device.

FIG. 9 illustrates a sequence of steps that can be performed by a third party application to detect movement of a mobile computing device, and in response to detecting movement of a mobile computing device.

FIG. 10 is a flow chart illustrating embodiments of exemplary methods for stretching an image received from a third party application to place on a display of a mobile computing device.

FIG. 11 is a flow chart illustrating embodiments of exemplary methods for automatically resizing text received from a third party application to fit a display of a mobile computing device.

FIG. 12 is a flow chart illustrating embodiments of exemplary methods for rendering a string formatted in Hypertext Markup Language received from a third party application and placing the rendered Hypertext Markup Language string on a display of a mobile computing device.

FIG. 13A illustrates an example embodiment of a mobile device.

FIG. 13B illustrates an example embodiment of a configurable top-level graphical user interface of a mobile device.

FIG. 14 is a block diagram of an example implementation of a mobile device.

### DETAILED DESCRIPTION

The present disclosure generally relates to providing third party applications a standardized framework for presenting user interface elements for its content. In particular, embodiments may provide application programming interfaces (APIs) to user interface views and user interface control elements. In some embodiments, the APIs may provide user interface views and control elements that can be arranged in a stack, which can allow for efficient transition and navigation between the various views of the third party applications as well as other applications on a device.

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

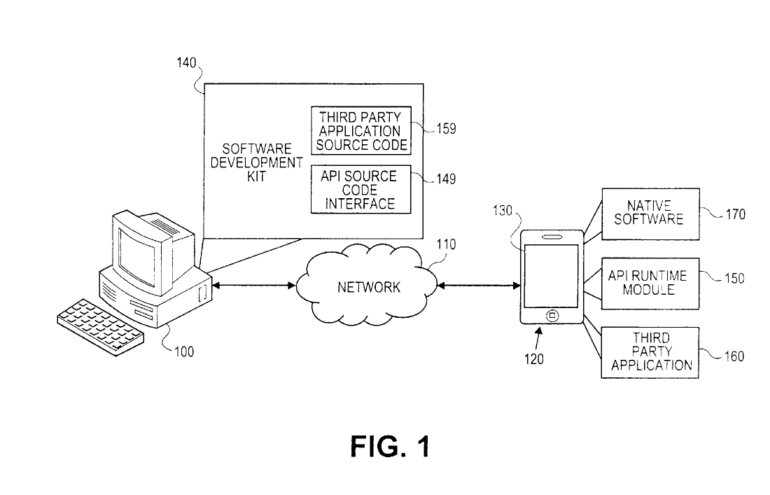

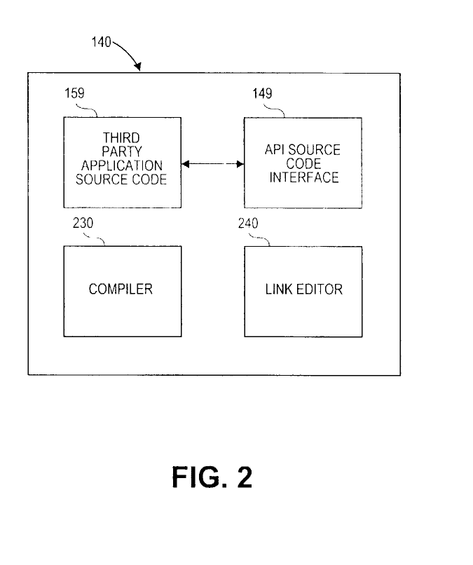

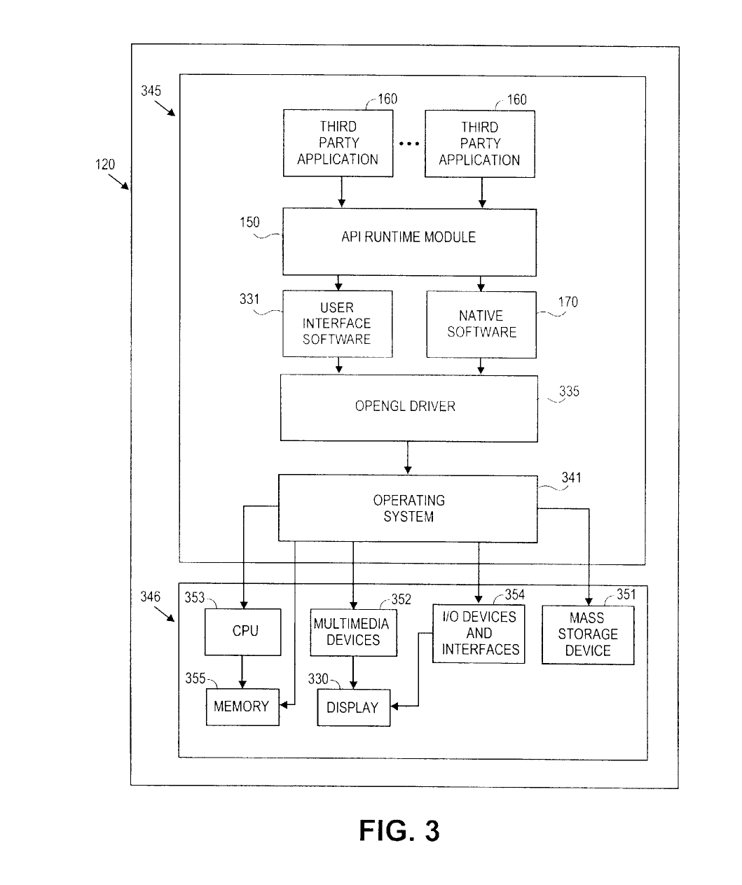

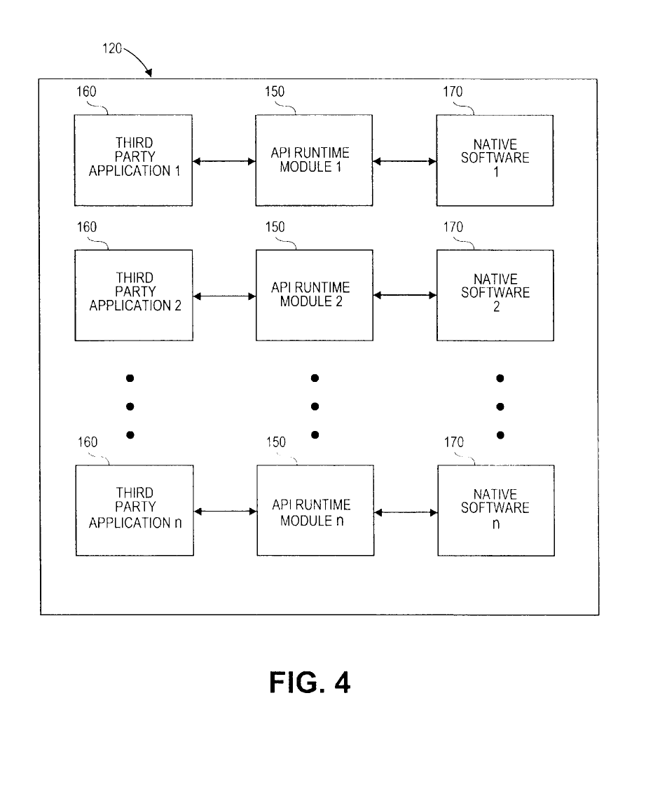

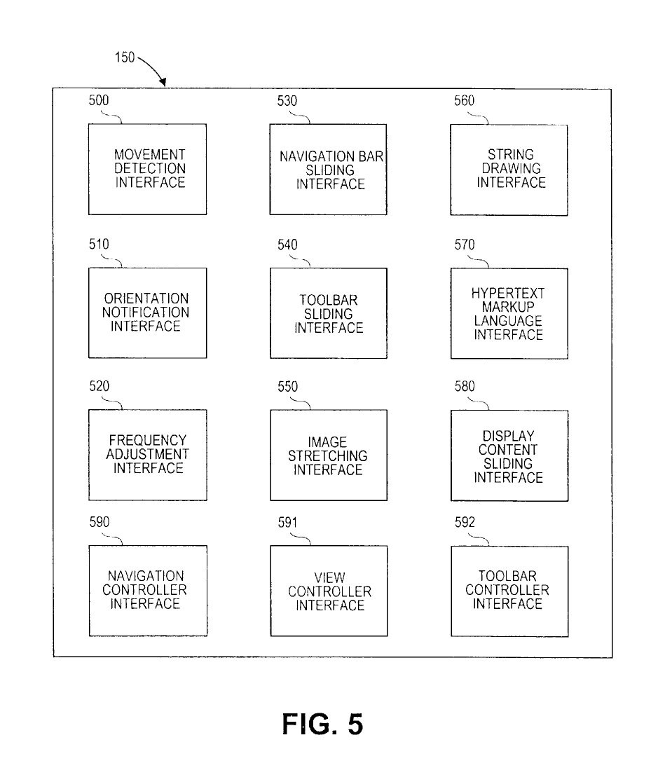

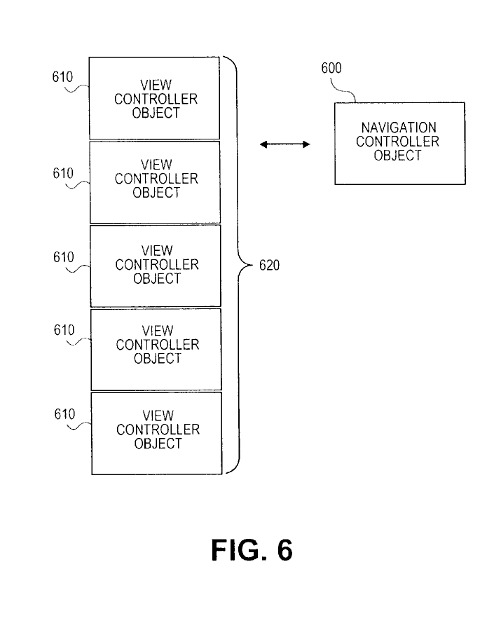

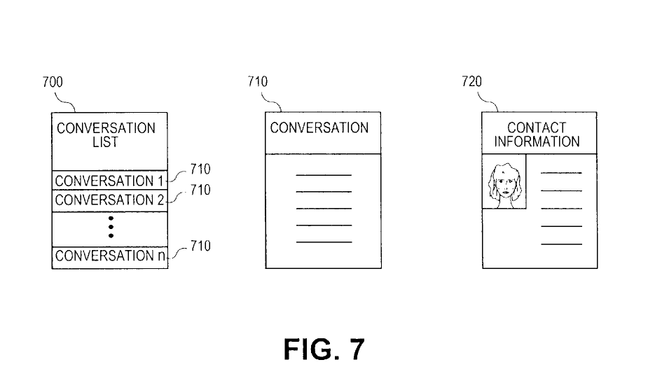

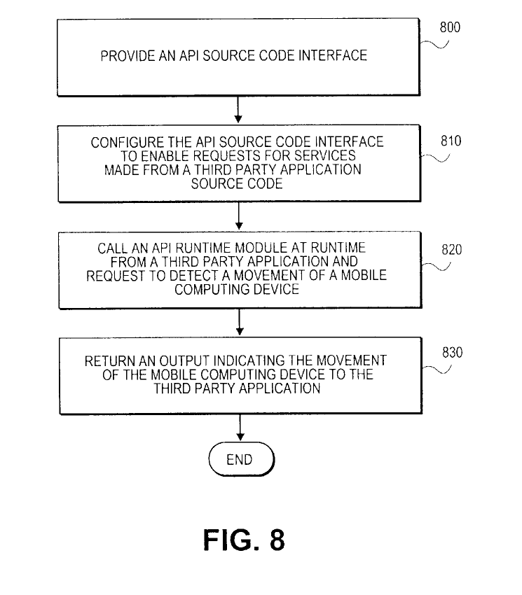

In order to help illustrate the embodiments, FIGS. 1-12 will now be presented. FIG. 1 illustrates an exemplary development system in which a developer may use a software development kit to configure their third party application to utilize various APIs for user interface views and control elements. FIG. 2 illustrates a block diagram of the software development kit. FIGS. 3-4 are then provided to show block diagrams of a mobile computing device and various third party applications running on the mobile computing device. FIG. 5 illustrates examples of APIs to user interface views and control elements that may be called by the third party applications. FIG. 6 illustrates an example of a stack of user interface views that may be employed by the third party applications via various APIs. FIG. 7 illustrates exemplary displays of content by a third party application using APIs of the present invention. FIGS. 8-12 provide several flow charts that illustrate how third party applications are configured to utilize APIs for user interface views and control elements and call these APIs at runtime. Reference will now be made to FIG. 1 in order to describe an exemplary development system.

As shown in FIG. 1, computing system 100 may be in communication with network 110, and/or mobile computing device 120 may also in communication with network 110. Communication over network 110 can take place using sockets, ports, and/or other mechanisms recognized in the art. Mobile computing device 120 includes display 130 to place content, such as animation, for viewing by a user of the device.

Mobile computing device 120 can be a cell phone, smart phone, personal digital assistant, audio player, and/or the like. For example, in some embodiments, mobile computing device 120 can be an Apple iPhone™, iPod™, and the like.

Mobile computing device 120 can further include application programming interface runtime module 150. Runtime module 150 can be configured to enable third party application 160 to communicate with native software 170 to place content on display 130 of the computing device 120. Third party application 160 can use application programming interface runtime module 150 to make requests for services of native software 170. Third party application 160 can be a variety of different applications, such as games, tools, etc.

Native software 170 may generally represent software installed on mobile computing device 120 that supports the execution of third party application 160. For example, native software 170 may refer to the operating system, user interface software, graphics drivers, and the like that is installed and running on mobile computing device 120.

In order to configure third party application 160, computing system 100 can include software development kit 140. Software development kit 140 can allow a developer to configure third party application source code 159 to access application programming interface (API) source code interface 149. For example, in some embodiments, application programming interface (API) source code interface 149 can include a header file written in the Objective-C programming language.

Third party application source code 159 can be compiled into third party application 160, in the form of object code. This object code can then be linked to application programming interface (API) runtime module 150. API runtime module 150 can include one or more executable object code interfaces to native software 170 that implement and/or correspond to API source code interface 149 provided to third party application source code 159. Native software 170 can include object code that is readable by mobile computing device 120.

Third party application 160, application programming interface runtime module 150, and native software 170 can then be stored and executed on mobile computing device 120. The term application programming interface (API) is used herein to refer generally to the interface(s) for making service requests provided by API source code interface 149 (source code level) to third party application source code 159 or API runtime module 150 (object code level) to third party application 160.

Software development kit 140 can be configured to enable third party application 160 to be written for mobile computing device 120. Network 110 can then be used, in some embodiments, to transfer and load third party application 160 onto mobile computing device 120. In some embodiments, third party application 160 can be configured to use application programming interface runtime module 150 to place its content within user interface views and accompanying control elements on display 130 of mobile computing device 120 at runtime. In some embodiments, application programming interface runtime module 150 can provide various interfaces to the native software 170. Native software 170 can then be called at runtime to place the viewing content on display 130 of mobile computing device 120.

The functionality provided for in the components, applications, application programming interfaces, and/or modules described herein can be combined and/or further separated. In general, the words module, interface, and/or application as used herein, refers to logic embodied in hardware or firmware, or to a collection of software instructions, possibly having entry and exit points, written in a programming language, such as, for example, Java, Objective-C, C or C++. A software module, interface, and/or application may be compiled and linked into an executable program, installed in a dynamic link library, or may be written in an interpreted programming language such as, for example, BASIC, Perl, or Python. It will be appreciated that software modules, interfaces, and/or applications may be callable from other modules and/or applications, or from themselves, and/or may be invoked in response to detected events or interrupts. Software instructions may be embedded in firmware, such as an EPROM. It will be further appreciated that hardware modules, interfaces and/or applications may include connected logic units, such as gates and flip-flops, and/or may include programmable units, such as programmable gate arrays or processors. The modules, interfaces and/or applications described herein are preferably implemented as software modules, interfaces, and/or applications, but may be represented in hardware or firmware. Generally, the modules, interfaces, and/or applications described herein refer to logical modules, interfaces, and/or applications that may be combined with other modules, interfaces, and/or applications or divided into sub-modules, sub-interfaces, and/or sub-applications despite their physical organization or storage.

FIG. 2 illustrates a block diagram of the software development kit of FIG. 1. Software development kit 140 may be configured to enable third party application source code 159 to access API source code interface 149 to animate content on display 130 of mobile computing device 120. API source code interface 149 can include a header file.

In various embodiments, software development kit 140 may be used to help interface with native software 170. Native software 170 represents any software that was natively installed on mobile computing device 120. For example, in the present disclosure, native software 170 may refer to user interface software 331, graphics driver 335, and operating system 341.

For the developer, software development kit 140 can also include compiler 230. Compiler 230 can be configured to translate third party application source code 159 into a target form, referred to herein as third party application 160. The form of third party application 160 can include object code and/or binary code. Advantageously, compiler 230 can provide an option of generating object code that can be run on computing system 100 or mobile computing device 120. Compiler 230 can be a compiler for object-oriented languages such as Java, Objective-C, Ada, or C++, or a compiler for procedural languages, such as C.

Software development kit 140 can also include link editor 240. In some embodiments, third party application source code 159 can be compiled into third party application 160. Link editor 240 can then be used to link third party application 160 to API runtime module 150. A service request can then be sent from third party application 160 to API runtime module 150 on mobile computing device 120 at runtime. When loaded on mobile computing device 120, third party application 160 can then access native software 170 through API runtime module 150. In an embodiment, third party application 160 can then access native software 170 to place content on display 130 of mobile computing device 120.

In some embodiments, the service request can include sending as input to an application programming interface (API) a string of a first size for scaling to a second size such that the second size fits display 130 of mobile computing device 120. In some embodiments, the service request can include requesting the API to detect movement of mobile computing device 120, and in response to a detection of movement requesting the API to adjust an orientation of the content on display 130. In some embodiments, the service request can include sending as input to the API a first image for stretching and displaying on mobile computing device 120. In some embodiments, the service request can include rendering and displaying on mobile computing device 120 an input text string formatted in a Hypertext Markup Language (HTML).

FIG. 3 illustrates a block diagram of a mobile computing device 120. As shown, mobile computing device 120 may include a software level 345 and hardware level 346. At software level 345, third party application 160 may utilize application programming interface (API) runtime module 150 to request services from user interface software 331 or graphics driver 335 to display content on display 330.

In block 331, user interface software 331 may help render certain aspects, such as animations, of the document content and document presentation. User interface software 331 can be a data visualization software that is used by Apple's Mac OS X 10.5 to produce animated user interfaces. In some embodiments, for example, user interface software 331 can include Core Animation. Through API runtime module 150, user interface software 331 provides a way for third party developers to produce animated user interfaces via an implicit animation model. User interface software 331 is provided as an example of native software 170 and one skilled in the art will recognize that a third party application 150 may interface with other native applications, such as graphics driver 335 and one or more components of operating system 341.

In block 335, an graphics driver 335 may be used by user interface software 331 to help render any animations in third party application 160. In some embodiments, graphics driver 335 may be an OpenGL-based driver. OpenGL is a standard specification defining a cross-language cross-platform API for writing applications that produce 2D and 3D computer graphics. OpenGL can be used to draw complex three-dimensional scenes from simple primitive shapes or models. It may be appreciated that other hardware or software acceleration may be used to help render any animations in third party application 160.

Operating system (OS) layer 341 may control mobile computing device 120. Operating system layer 341 may include Mac OS X, Linux, Windows, or any number of proprietary operating systems. Conventional operating systems control and schedule computer processes for execution, perform memory management, provide file system, networking, and I/O services, and provide a user interface, such as a graphical user interface (GUI), among other things.

In hardware level 346, mobile computing device 120 can include memory 355, such as random access memory (RAM) for temporary storage of information and a read only memory (ROM) for permanent storage of information, and mass storage device 351, such as a hard drive, diskette, or optical media storage device. Mass storage device 351 may include one or more hard disk drives, optical drives, networked drives, or some combination of various digital storage systems. Mobile computing device 120 also includes central processing unit (CPU) 353 for computation. Typically, the modules of the computing device 120 are in data communication via one or more standards-based bus systems. In different embodiments, the standards based bus system could be Peripheral Component Interconnect (PCI), Microchannel, SCSI, Industrial Standard Architecture (ISA) and Extended ISA (EISA) architectures, for example.

The exemplary mobile computing device 120 may include one or more of commonly available input/output (I/O) devices and interfaces 354, such as a touchpad, or keypad. In one embodiment, I/O devices and interfaces 354 include display 330 that allows the visual presentation of data to a user. More particularly, display devices provide for the presentation of GUIs, application software data, and multimedia presentations, for example. In one embodiment, a GUI includes one or more display panes in which images may be displayed. Mobile computing device 120 may also include one or more multimedia devices 352, such as speakers, video cards, graphics accelerators, and microphones. Multimedia devices 352 can include a graphics processing unit. Exemplary mobile computing devices 120 may include devices, such as Apple's iPhone™ and iPod™ touch devices.

FIG. 4 illustrates a high level architecture for the mobile computing device of FIG. 1. In the illustrated embodiment, mobile computing device 120 is configured to handle service requests to display content on mobile computing device 120 from third party applications 160 to native software 170. The content to place on display 130 of mobile computing device 120 can include animated content. As depicted in FIG. 4, a multitude of third party applications 160 can communicate with a multitude of API runtime modules 150. In the illustrated embodiments, the multitude of API runtime modules 150 can then each communicate with native software 170. In alternate embodiments, the multitude of API runtime modules 150 may each connect to a multitude of native software 170.

In some embodiments, when third party application 160 is executed, it can make a service request that includes calling API runtime module 150, which in turn can call the native software 170. API runtime module 150 can further be configured to return data to third party application 160 in response to a service request. API runtime module 150 can be configured to provide an interface to place content on display 130 of mobile computing device 120 to third party application 160. Advantageously, API runtime module 150 can access native software 170 without exposing the underlying implementation details to third party application 160.

As depicted by FIG. 4, the architecture is applicable to any environment that is designed to include third party applications 160, including mobile computing devices 120. The system allows for an immediate improvement in the security of native software 170 by hiding their implementation details from third party applications 160. The system also allows native software 170 to be modified without affecting third party application 160.

FIG. 5 illustrates API runtime module 150 of FIG. 3, and illustrates exemplary interfaces. The interfaces can also correspond to the interfaces provided by API source code interface 149 to third party application source code 159. As described herein, the interfaces in source code or object code form may be referred to as APIs. The interfaces illustrated can, in some embodiments, be divided or combined with other interfaces and/or be included in one or more separate APIs. Some of the APIs that may be offered will now be further described.

Movement detection interface 500 can be configured to enable third party application 160 to communicate with native software 170 to detect when mobile computing device 120 changes orientation. In some embodiments, the movement may be any of the following: rotation, velocity, acceleration, leftwards, rightwards, upwards, and/or downwards.

Orientation notification interface 510 can be configured to enable third party application 160 to register and/or subscribe to receive an automatic notification when mobile computing device 120 changes orientation. In some embodiments, an accelerometer can be used to detect changes in the orientation of mobile computing device 120. The notification can be in the form of X, Y, and/or Z plane coordinate values. In some embodiments, delta values can be provided.

Frequency adjustment interface 520 can be configured to enable third party application 160 to adjust a frequency in which the notification of the orientation change for mobile computing device 120 is received. The notification frequency can be set to any value, including 1 Hz to 100 Hz.

Navigation bar sliding interface 530 can be configured to enable third party application 160 to slide a navigation bar on display 130 of mobile computing device 120 in response to detecting the movement of mobile computing device 120. In some embodiments, the navigation bar orientation on display 130 can be changed, including by rotating the navigation bar into a portrait orientation from a landscape orientation and/or vice versa.

Toolbar sliding interface 540 can be configured to enable third party application 160 to slide a toolbar on display 130 of mobile computing device 120 in response to detecting the movement of mobile computing device 120. In some embodiments, the toolbar orientation on display 130 can be changed, including by rotating the toolbar into a portrait orientation from a landscape orientation and/or vice versa.

Display content sliding interface 580 can be configured to enable third party application 160 to slide the content on display 130 of mobile computing device 120 in response to detecting the movement of mobile computing device 120. In some embodiments, the display content orientation on display 130 can be changed, including by rotating the display content into a portrait orientation from a landscape orientation and/or vice versa.

Image stretching interface 550 can be configured to receive as an input a first image from third party application 160, and return as an output a second image for displaying on the mobile computing device 130. Image stretching interface 550 can further be configured to output the second image on display 130 of mobile computing device 120. In some embodiments, the second image can include the first image stretched along a horizontal gradient. In some embodiments, the second image can include the first image stretched along a vertical gradient. Advantageously, image stretching interface 550 enables the first image to occupy less storage space. In some embodiments, image stretching interface 550 can be configured to receive as an input from third party application 160 a first image and dimensions to make the second image. Image stretching interface 550 can be configured to generate the second image using the inputs, do a pixel fill, and/or manipulate pixels to generate the second image.

String drawing interface 560 can be configured to receive as an input a first string of a first text size from third party application 160, and in response output a second string. The second string can be scaled to a second text size such that the second text size fits display 130 of mobile computing device 120. String drawing interface 560 can further be configured to return to third party application 160 the second text size. Third party application 160 can be configured to subsequently provide input of the second text size to string drawing interface 560. In some embodiments, the second text size can inhibit truncation of the text string on display 130 of mobile computing device 120. In some embodiments, the second text size can reduce scrolling through display 130 of mobile computing device 120.

HTML interface 570 can be configured to receive as an input a string including text formatted in a Hypertext Markup Language. HTML interface 570 can further be configured to render the string to display 130 of the computing device 120.

Navigation controller interface 590 can be configured to enable one or more third party applications 160 to manage, manipulate, and/or place content on display 130 of mobile computing device 120. In some embodiments, navigation controller interface 590 can be configured to manage a stack of one or more objects of view controller interface 591. Navigation controller interface 590 can provide an interface to a stack of views that are part of a hierarchy of views. The interface can allow third party application 160 to enter a view onto the stack and returns views from the stack until a requested view is on top of the stack.

View controller interface 591 can be configured to enable third party application 160 to place content on display 130 of mobile computing device 120. The content can include a view that describes graphical elements to display, including animations, toolbars, or navigation bars. In some embodiments, view controller interface 591 can have multiple object instances that are placed on a data structure, such as a stack and/or tree, managed by navigation controller interface 590.

In some embodiments, a view interface can be used to receive a description of graphical interface elements as an input to describe a view to place on the display. View controller interface 591 can then be configured to show or hide the view. The navigation controller 590 can then be used to perform horizontal view transitions for pushed and popped views while keeping a navigation bar synchronized. Third party application 160 can then add a view to the view hierarchy and then push and pop controllers. Advantageously, navigation controller interface 590, view controller interface 591, and/or toolbar controller interface 592 provide a simplified interface for third party applications 590 to manage view transitions on display 130 of the handheld computing device 120.

Toolbar controller interface 592 can be configured to enable third party application 160 to place a toolbar on display 130 of mobile computing device 120. In some embodiments, toolbar controller interface 592 can be configured to provide a simplified mechanism to create, display, manipulate, and/or manage a toolbar on display 130 to third party application 160 with different modes. In some embodiments, toolbar controller interface 592 can be configured to provide a simplified interface of placing buttons on a toolbar, responding to a button click, and/or managing the state when a button is clicked.

For example, when third party application 160 is a clock application a user can specify a world clock, stop watch, and/or timer to be placed on the toolbar. Toolbar controller interface 592 can be configured to create views, place buttons, and/or manage the state of the toolbar. Advantageously, toolbar controller interface 592 can provide a simplified interface to display and/or manage a toolbar on display 130 of mobile computing device 120 to third party application 160.

In some embodiments, the views managed by toolbar controller interface 592 can be managed in a data structure that can be moved across and/or accessed freely in a non-hierarchical manner, such as a list. Each entry in the data structure can be a distinct mode without any hierarchy. Each mode within the data structure can be tracked and/or switched into from any another mode. In some embodiments, a mode can correspond to an object instance of navigation controller interface 590. In some embodiments, a stack and/or tree of object instances of toolbar controller interface 592 can be used to place content on display 130 of mobile computing device 120. Advantageously, the stack can enable tracking the state of other toolbars and/or maintain a hierarchy across multiple third party applications 160.

FIG. 6 illustrates an example runtime environment for displaying content on mobile computing device 120 that includes instances of navigation controller interface 590 and view controller interface 591 of FIG. 5. In some embodiments, API runtime module 150, native software 170, and/or third party application 160 can utilize stack-based architecture 620 to manage various user interface elements to place on display 130 of mobile computing device 120. API runtime module 150 can include navigation controller interface 590.

In some embodiments, there can be one or more navigation controller object instances 600 of navigation controller interface 590. Navigation controller interface 590 can be configured to enable third party application 160 to navigate through a structure, such as a tree, to place content, including animation, on display 130 of mobile computing device 120. Navigation controller interface 590 can be further configured to manage stack 620 of one or view controller object instances 610 of view controller interface 591. In some embodiments, navigation controller interface 590 can be called and/or requested to push and/or pop view controller object 610 from stack 620 by third party application 160 to display content on mobile computing device 120. In some embodiments, the number of calls, including method calls, and/or service requests to navigation controller interface 590 and/or view controller interface 591 can be less than the number typically required by third party application 160 to display content on mobile computing device 120.

Advantageously, navigation controller interface 590 provides a simplified mechanism to display graphical elements to third party application 160 without requiring third party application 160 to track state. In some embodiments, navigation controller interface 590 can be configured to create a navigation view, manage the state of stack 620, transition views on display 130, and/or synchronize multiple transitions on display 130. In some embodiments, navigation controller interface 590 can enable the user interface content and/or other display content to match up with the abstract state underneath that can be represented by stack 620 of view controller objects 610.

In some embodiments, navigation controller interface 590 can provide a high level interface to build up an animation to third party application 160. Navigation controller interface 590 can be configured to abstract away the details of a graphics library such as OpenGL. In some embodiments navigation controller interface 590 can be configured to manage the Core Animation application programming interface and/or OpenGL so that a user does not need to request services directly. Navigation controller interface 590 can combine OpenGL and the Core Animation application programming interface into a single interface.

In some embodiments, view controller interface 591 can be accessed by third party application 160. Third party application 160 can be configured to create multiple instances of view controller interface 591. For example, in some embodiments where third party application 160 includes an email program there can be a separate view controller object 610 for showing contacts, displaying a message, and/or sending a message. In some embodiments, view controller object 610 can be configured as a container for the content to place on display 130. Navigation controller object 600 can, in some embodiments, be configured to move and/or position the view controller objects 610 on display 130 of mobile computing device 120.

In some embodiments, navigation controller interface 590 can be configured to set and/or position a parent view controller object 610, position a child view controller object 610 on display 130, and/or push and/or pop the view controller objects 610 from stack 620. Navigation controller interface 590 can be further configured to inform the parent view controller 610 to hide, place a new view controller object 610 on display 130, and/or begin a transition so that the animation of the new view controller object 610 appears on display 130. In some embodiments, navigation controller interface 590 can be further configured to update an instance of the navigation bar interface 590 to track the current mode, notify the new view controller object 610 that the animation transition has finished, and/or notify third party application 160 that the state has changed.

Navigation controller interface 590, view controller interface 591, and/or toolbar controller interface 592 provide a simplified paradigm to display content on mobile computing device 120. Advantageously, navigation controller interface 590, view controller interface 591, and/or toolbar controller interface 592 can be configured to simplify user interface design elements, while managing transitions and/or the current state of the display hierarchy. Navigation controller interface 590, view controller interface 591, and/or toolbar controller interface 592 can be configured to maintain state, synchronize animations, and/or handle the different third party application 160 use cases for animating content. Navigation controller interface 590 can be configured to abstract from third party application 160 the creation of user interface view transitions, setting a duration of the transitions, setting an animation curve, setting a start frame, and/or setting an end frame. In some embodiments, navigation controller interface 590, view controller interface 591, and/or toolbar controller interface 592 can be configured to enable third party applications 160 to have a similar look and feel as native software applications 170.

Navigation controller interface 590 can also be configured to enable pluggable view controllers. In some embodiments, the pluggable view controller can push other view controller objects 610 onto stack 620 without actual knowledge of stack 620 itself. For example, third party application 160 can, in some embodiments, call navigation controller interface 590 to push another view controller object 610 on stack 620. In some embodiments, when view controller object 610 is pushed onto stack 620, it can push another view controller object 610 and/or expose itself to third party applications 160 and/or other view controller objects 610.

FIG. 7 illustrates example content of third party application 160 that can be displayed on mobile computing device 120 by navigation controller interface 590 and view controller interface 591 of FIG. 5. In the illustrated embodiments, third party application 160 can include a Short Message Service (SMS) application.

The SMS application can include content such as conversation list 700, which includes one or more conversations 710 to place on display 130 of mobile computing device 120. In some embodiments, if a user selects a conversation the user can obtain contact information 720 that can be placed on display 130. Conversation list 700, conversations 710, and/or contact information 720 can each be managed by view controller interface 591. In some embodiments, the display of each of these can be associated with a separate view controller object 610. The combined state of conversation list 700, conversations 710, and/or contact information 720 can be managed by one or more object instances of navigation controller interface 590 by utilizing stack 620.

Navigation controller interface 590 can provide a high level push and/or pop interface of view controller objects 610 and/or provide automatic display updates to the SMS application. In an embodiment, navigation controller interface 590 can be provided a high level tree of view controller objects 610, such as stack 620, and automatically update display 130 of mobile computing device 120. Navigation controller interface 590 can be configured to manage the stack state and/or ensure that view controller objects 610 display on mobile computing device 120 correctly. In some embodiments, navigation controller interface 590 can be further configured to combine animations. For example, three view controller objects 610 on stack 620 can be combined by navigation controller interface 590 into one animation.

In some embodiments, navigation controller interface 590 can be configured to call the Core Animation API, update the state of stack 620, update the navigation bar buttons to match the properties of view controller object 610, and/or notify view controller object 610 when the animation transition starts and/or stops. Advantageously, navigation controller interface 590 abstracts the implementation details of the underlying animation by providing a push and/or pop interface. Navigation controller interface 590 can also advantageously manage the start and stop of a transition.

Navigation controller interface 590 can allow third party application 160 to place overlays on display 130. For example, in the SMS application there can be a navigation hierarchy. In some embodiments, a user composing a new conversation 710 can obtain an overlay. Navigation controller interface 590 can simplify the overlaying process by creating a separate stack (not shown) for the overlay. Advantageously, the separate stack creates a new hierarchy that provides an overlay, while not interfering with the state of stack 620.

FIG. 8 is a flow chart illustrating embodiments of exemplary methods for handling a service request received from third party application 160 to detect movement of mobile computing device 120. In step 800, API source code interface 149 is provided to third party application source code 159. API source code interface 149 can include one or more interfaces. API source code interface 149 can abstract away the details of implementation of the native software 170. Native software 170 and/or API source code interface 149 can include one or more modules, object-oriented software classes, objects, functions, and/or data structures that can allow third party application source code 159 to animate content on display 130 of mobile computing device 120 after compilation and linking to API runtime module 150.

In step 810, API source code interface 149 can be configured to enable requests for services made from third party application source code 159. API source code interface 149 can enable third party application source code 159 to call native software 170 to request services by providing interfaces at the source code level. In some embodiments, the interfaces can be written in the languages of Java, Objective-C, C++, and/or C. API source code interface 149 can provide the one or more interfaces to enable requests for services made from third party application source code 159. In some embodiments, application programming interface runtime module 150 can then enable third party application 160 to call native software 170 at runtime to request services.

API runtime module 150 can be configured to receive a request from third party application 160 to detect movement of mobile computing device 120 at runtime. In some embodiments, API runtime module 150 can include movement detection interface 500. Movement detection interface 500 can be configured to enable a service request from third party application 160 to detect movement of mobile computing device 120. An accelerometer can be used, in some embodiments, to detect movement of mobile computing device 120. Movement detection interface 500 can be further configured to call native software 170 at runtime, in response to receiving the service request from third party application 160. In an alternate embodiment, software development kit 140 can be used to enable third party application source code 159 to call an interface of API source code interface 149 corresponding to the source code of movement detection interface 500.

In step 820, third party application 160 calls the interface of API runtime module 150 at runtime to detect a movement of mobile computing device 120. In some embodiments, the movement may be any of the following: rotation, velocity, acceleration, leftwards, rightwards, upwards, and/or downwards. In some embodiments, movement detection interface 500 can be called to detect the movement of mobile computing device 120. Movement detection interface 500 can further be configured to call native software 170 such as an accelerometer class to detect the movement of mobile computing device 120.

In step 830, an output indicating the movement of mobile computing device 120 is returned to third party application 160. In some embodiments, the output can be in the form of X, Y, and/or Z plane coordinate values indicating the current orientation and/or position of mobile computing device 120. In some embodiments, delta values from the previous position of mobile computing device 120 can be returned to third party application 160.

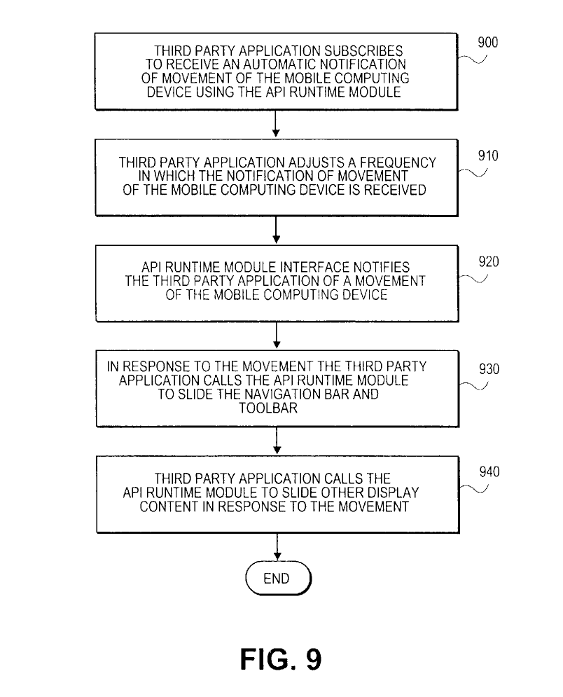

FIG. 9 illustrates a sequence of steps that can be performed by third party application 160 to automatically detect movement of mobile computing device 120. In step 900, third party application 160 subscribes to receive an automatic notification of movement of mobile computing device 120 using API runtime module 150. In some embodiments, API runtime module 150 can include orientation notification interface 510. Orientation notification interface 510 can be configured to enable third party application 160 to register and/or subscribe to receive an automatic notification when mobile computing device 120 changes orientation. In some embodiments, an accelerometer can be used to detect changes in the orientation of mobile computing device 120. The notification can be in the form of X, Y, and/or Z plane coordinate values. In some embodiments, delta values can be provided. Orientation notification interface 510 can be further configured to call native software 170 at runtime, in response to receiving the service request from third party application 160. In an alternate embodiment, software development kit 140 can be used to enable third party application source code 159 to call an interface of API source code interface 149 corresponding to the source code of orientation notification interface 510.

In step 910, third party application 160 adjusts a frequency in which the notification of movement of mobile computing device 120 is received by third party application 160. In some embodiments, API runtime module 150 can include frequency adjustment interface 520. Frequency adjustment interface 520 can be configured to enable third party application 160 to adjust a frequency in which the notification of the orientation change for mobile computing device 120 is received. The notification frequency can be set to any value, including 1 Hz to 100 Hz. In some embodiments, frequency adjustment interface 520 can be further configured to call native software 170 at runtime, in response to receiving the service request from third party application 160. In an alternate embodiment, software development kit 140 can be used to enable third party application source code 159 to call an interface of API source code interface 149 corresponding to the source code of frequency adjustment interface 520.

In step 920, API runtime module 150 notifies third party application 160 of a movement of mobile computing device 120. In some embodiments, API runtime module 150 can include orientation notification interface 510 described herein. In some embodiments, orientation notification interface 510 can be further configured to call native software 170 and/or third party application 160 at runtime, in response to receiving the service request from third party application 160. In an alternate embodiment, software development kit 140 can be used to enable third party application source code 159 to call an interface of API source code interface 149 corresponding to the source code of orientation notification interface 510.

In step 930, third party application 160 calls API runtime module 150 to slide a navigation bar and/or a toolbar. In some embodiments, third party application 160 can call API runtime module 150 in response to receiving a movement notification. The movement notification can be received in response to a service request to movement detection interface 500 and/or orientation notification interface 510.

API runtime module 150 can include navigation bar sliding interface 530. Navigation bar sliding interface 530 can be configured to enable third party application 160 to slide the navigation bar on display 130 of mobile computing device 120 in response to detecting the movement of mobile computing device 120. In some embodiments, the navigation bar orientation on display 130 can be changed, including by rotating the navigation bar into a portrait orientation from a landscape orientation and/or vice versa. API runtime module 150 can further include toolbar sliding interface 540. Toolbar sliding interface 540 can be configured to enable third party application 160 to slide the toolbar on display 130 of mobile computing device 120 in response to detecting the movement of mobile computing device 120. In some embodiments, the toolbar orientation on display 130 can be changed, including by rotating the toolbar into a portrait orientation from a landscape orientation and/or vice versa. In an alternate embodiment, software development kit 140 can be used to enable third party application source code 159 to call an interface of API source code interface 149 corresponding to the source code of navigation bar sliding interface 530 or toolbar sliding interface 540.

In step 940, the third party application calls API runtime module 150 to slide other display content in response to receiving the movement notification. In some embodiments, API runtime module 150 can include display content sliding interface 580. Display content sliding interface 580 can be configured to enable third party application 160 to slide the content on display 130 of mobile computing device 120 in response to detecting the movement of mobile computing device 120. In some embodiments, the display content orientation on display 130 can be changed, including by rotating the display content into a portrait orientation from a landscape orientation and/or vice versa. In some embodiments, display content sliding interface 580 can be further configured to call native software 170 and/or third party application 160 at runtime, in response to receiving the service request from third party application 160. In an alternate embodiment, software development kit 140 can be used to enable third party application source code 159 to call an interface of API source code interface 149 corresponding to the source code of display content sliding interface 580.

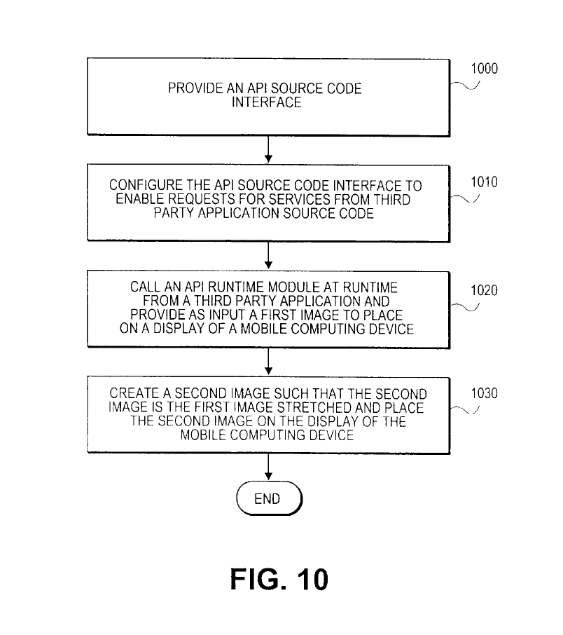

FIG. 10 is a flow chart illustrating embodiments of exemplary methods for stretching an image received from third party application 160 to place on display 130 of mobile computing device 120. In step 1000, API source code interface 149 is provided to third party application source code 159. API source code interface 149 can include one or more interfaces. API source code interface 149 can abstract away the details of implementation of the native software 170. Native software 170 and/or API source code interface 149 can include one or more modules, object-oriented software classes, objects, functions, and/or data structures configured to enable third party application source code 159 to animate content on display 130 of mobile computing device 120 after compilation and linking to API runtime module 150.

In step 1010, API source code interface 149 is configured to enable requests for services made from third party application source code 159. API source code interface 149 can enable third party application source code 159 to call native software 170 to request services by providing interfaces at the source code level. In some embodiments, the interfaces can be written in the languages of Java, Objective-C, C++, and/or C. API source code interface 149 can then provide the one or more interfaces to enable requests for services made from third party application source code 159. In some embodiments, application programming interface runtime module 150 can then enable third party application 160 to call native software 170 at runtime to request services.

API runtime module 150 can be configured to receive a request from third party application 160 to receive an image as an input to stretch and/or place on display 130 of mobile computing device 120 at runtime. In some embodiments, the interface can include image stretching interface 550. Image stretching interface 550 can be configured to enable a service request from third party application 160 to native software 170 to receive as an input a first image from third party application 160, and/or return as an output a second image for displaying on the mobile computing device 130. Image stretching interface 550 can further be configured to output the second image on display 130 of mobile computing device 120. In an alternate embodiment, software development kit 140 can be used to enable third party application source code 159 to call an interface of API source code interface 149 corresponding to the source code of image stretching interface 550.

In step 1020, third party application 160 calls the interface of API runtime module 150 at runtime and/or provides as the input a first image to place on display 130 of mobile computing device 120. In some embodiments, image stretching interface 550 can be called to stretch the first image and/or place the stretched image on display 130 of mobile computing device 120.

In step 1030, a second image is created such that the second image is the first image stretched. The second image can be placed on display 130 of mobile computing device 120. In some embodiments, the second image can include the first image stretched along a horizontal gradient. In some embodiments, the second image can include the first image stretched along a vertical gradient. Advantageously, image stretching interface 550 enables the first image to occupy less storage space. In some embodiments, image stretching interface 550 can be configured to receive as an input from third party application 160 a first image and dimensions to make the second image. Image stretching interface 550 can be configured to generate the second image using the inputs, do a pixel fill, and/or manipulate pixels to generate the second image.

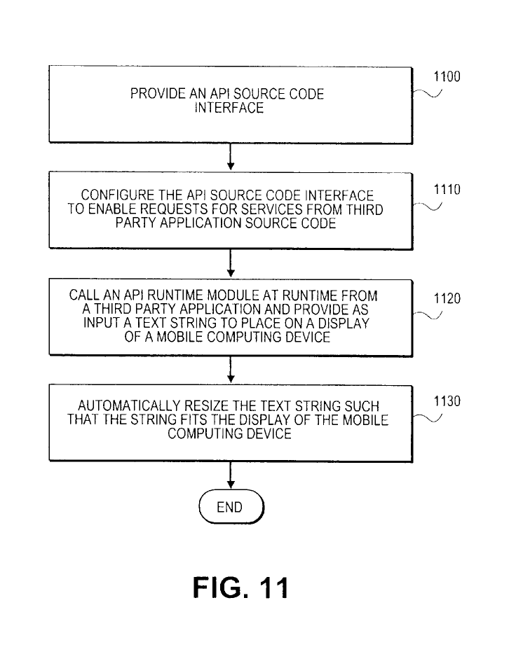

FIG. 11 is a flow chart illustrating embodiments of exemplary methods for automatically resizing text received from third party application 160 to fit display 130 of mobile computing device 120. In step 1100, API source code interface 149 is provided to third party application source code 159. API source code interface 149 can include one or more interfaces. API source code interface 149 can abstract away the details of implementation of the native software 170. Native software 170 and/or API source code interface 149 can include one or more modules, object-oriented software classes, objects, functions, and/or data structures configured to enable third party application source code 159 to animate content on display 130 of mobile computing device 120 after compilation and linking to API runtime module 150.

In step 1110, API source code interface 149 is configured to enable requests for services made from third party application source code 159. API source code interface 149 can enable third party application source code 159 to call native software 170 to request services by providing interfaces at the source code level. In some embodiments, the interfaces can be written in the languages of Java, Objective-C, C++, and/or C. API source code interface 149 can then provide the one or more interfaces to enable requests for services made from third party application source code 159. In some embodiments, application programming interface runtime module 150 can then enable third party application 160 to call native software 170 at runtime to request services.

API runtime module 150 can be configured to receive a request from third party application 160 to receive text as an input to automatically resize and/or place on display 130 of mobile computing device 120 at runtime. In some embodiments, the interface can include string drawing interface 560. String drawing interface 560 can be configured to enable a service request from third party application 160 to native software 170 to receive as an input a first string of a first text size from third party application 160, and in response output a second string. The second string can be scaled to a second text size such that the second text size fits display 130 of mobile computing device 120. String drawing interface 560 can further be configured to return to third party application 160 the second text size. Third party application 160 can be configured to subsequently provide input of the second text size to string drawing interface 560. In an alternate embodiment, software development kit 140 can be used to enable third party application source code 159 to call an interface of API source code interface 149 corresponding to the source code of string drawing interface 560.

In step 1120, third party application 160 calls the interface of API runtime module 150 at runtime and/or provides as the input a text string to place on display 130 of mobile computing device 120. In some embodiments, string drawing interface 560 can be called to resize the text string and/or place the resized text string on display 130 of mobile computing device 120.

In step 1130, the text string is automatically resized to a second text size such that the text string fits display 130 of mobile computing device 120. In some embodiments, the second text size can inhibit truncation of the text string on display 130 of mobile computing device 120. In some embodiments, the second text size can reduce scrolling through display 130 of mobile computing device 120.

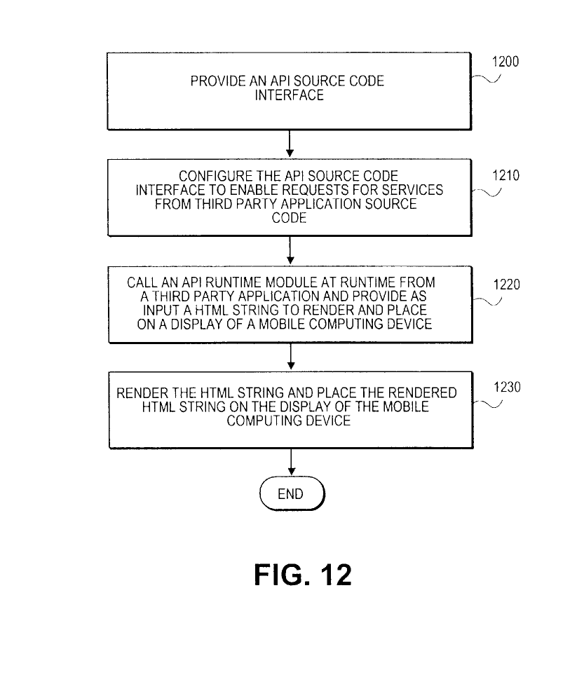

FIG. 12 is a flow chart illustrating embodiments of exemplary methods for rendering a string formatted in Hypertext Markup Language (HTML) received from third party application 160 and placing the rendered Hypertext Markup Language string on display 130 of mobile computing device 120. The process can, in some embodiments, be executed when a user interacts with mobile computing device 120 while using, for example, a web browser such as Apple Safari.

In step 1200, API source code interface 149 is provided to third party application source code 159. API source code interface 149 can include one or more interfaces. API source code interface 149 can abstract away the details of implementation of the native software 170. Native software 170 and/or API source code interface 149 can include one or more modules, object-oriented software classes, objects, functions, and/or data structures configured to enable third party application source code 159 to animate content on display 130 of mobile computing device 120 after compilation and linking to API runtime module 150.

In step 1210, API source code interface 149 is configured to enable requests for services made from third party application source code 159. API source code interface 149 can enable third party application source code 159 to call native software 170 to request services by providing interfaces at the source code level. In some embodiments, the interfaces can be written in the languages of Java, Objective-C, C++, and/or C. API source code interface 149 can then provide the one or more interfaces to enable requests for services made from third party application source code 159. In some embodiments, application programming interface runtime module 150 can then enable third party application 160 to call native software 170 at runtime to request services.

API runtime module 150 can be configured to receive a request from third party application 160 to receive a string formatted in HTML as an input to render and/or place on display 130 of mobile computing device 120 at runtime. In some embodiments, the interface can include HTML interface 570. HTML interface 570 can be configured to enable a service request from third party application 160 to native software 170 to receive as an input a string including text formatted in a Hypertext Markup Language. HTML interface 570 can further be configured to render the string to display 130 of mobile computing device 120. In an alternate embodiment, software development kit 140 can be used to enable third party application source code 159 to call an interface of API source code interface 149 corresponding to the source code of HTML interface 570.

In step 1220, third party application 160 calls the interface of API runtime module 150 at runtime and/or provides as the input the HTML string to render and/or place on display 130 of mobile computing device 120. In some embodiments, HTML interface 570 can be called to render the HTML string and/or place the rendered string on display 130 of mobile computing device 120.

In step 1230, the HTML string is rendered and/or placed on display 130 of mobile computing device 120. In some embodiments, a HTML rendering engine such as WebKit can be used to render the HTML string and/or any associated content.

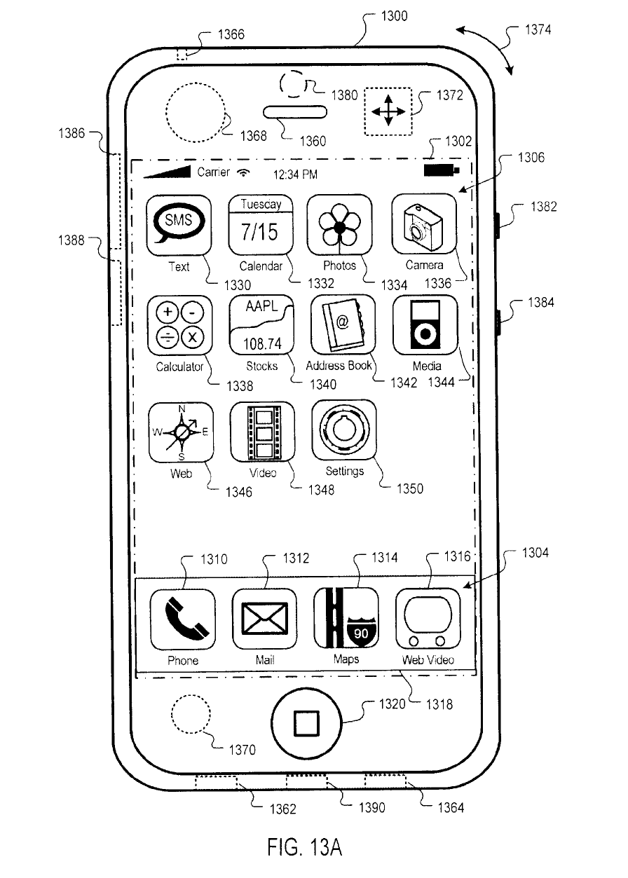

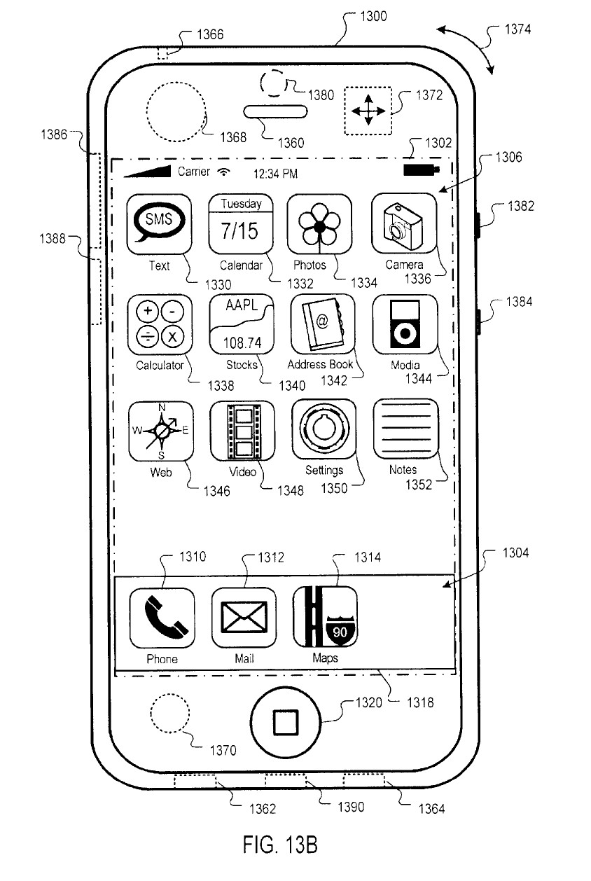

FIG. 13A illustrates an example mobile device 1300. The mobile device 1300 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

In some implementations, the mobile device 1300 includes a touch-sensitive display 1302. The touch-sensitive display 1302 can be implemented with liquid crystal display (LCD) technology, light emitting polymer display (LPD) technology, or some other display technology. The touch-sensitive display 1302 can be sensitive to haptic and/or tactile contact with a user.

In some implementations, the touch-sensitive display 1302 can include a multi-touch-sensitive display 1302. A multi-touch-sensitive display 1302 can, for example, process multiple simultaneous touch points, including processing data related to the pressure, degree, and/or position of each touch point. Such processing facilitates gestures and interactions with multiple fingers, chording, and other interactions. Other touch-sensitive display technologies can also be used, e.g., a display in which contact is made using a stylus or other pointing device. Some examples of multi-touch-sensitive display technology are described in U.S. Pat. Nos. 6,323,846, 6,570,557, 6,677,932, and 6,888,536, each of which is incorporated by reference herein in its entirety.

In some implementations, the mobile device 1300 can display one or more graphical user interfaces on the touch-sensitive display 1302 for providing the user access to various system objects and for conveying information to the user. In some implementations, the graphical user interface can include one or more display objects 1304, 1306. In the example shown, the display objects 1304, 1306, are graphic representations of system objects. Some examples of system objects include device functions, applications, windows, files, alerts, events, or other identifiable system objects.

In some implementations, the mobile device 1300 can implement multiple device functionalities, such as a telephony device, as indicated by a Phone object 1310; an e-mail device, as indicated by the Mail object 1312; a map devices, as indicated by the Maps object 1314; a Wi-Fi base station device (not shown); and a network video transmission and display device, as indicated by the Web Video object 1316. In some implementations, particular display objects 1304, e.g., the Phone object 1310, the Mail object 1312, the Maps object 1314, and the Web Video object 1316, can be displayed in a menu bar 1318. In some implementations, device functionalities can be accessed from a top-level graphical user interface, such as the graphical user interface illustrated in FIG. 13A. Touching one of the objects 1310, 1312, 1314, or 1316 can, for example, invoke a corresponding functionality.

In some implementations, the mobile device 1300 can implement a network distribution functionality. For example, the functionality can enable the user to take the mobile device 1300 and provide access to its associated network while traveling. In particular, the mobile device 1300 can extend Internet access (e.g., Wi-Fi) to other wireless devices in the vicinity. For example, mobile device 1300 can be configured as a base station for one or more devices. As such, mobile device 1300 can grant or deny network access to other wireless devices.

In some implementations, upon invocation of a device functionality, the graphical user interface of the mobile device 1300 changes, or is augmented or replaced with another user interface or user interface elements, to facilitate user access to particular functions associated with the corresponding device functionality. For example, in response to a user touching the Phone object 1310, the graphical user interface of the touch-sensitive display 1302 may present display objects related to various phone functions; likewise, touching of the Mail object 1312 may cause the graphical user interface to present display objects related to various e-mail functions; touching the Maps object 1314 may cause the graphical user interface to present display objects related to various maps functions; and touching the Web Video object 1316 may cause the graphical user interface to present display objects related to various web video functions.

In some implementations, the top-level graphical user interface environment or state of FIG. 13A can be restored by pressing a button 1320 located near the bottom of the mobile device 1300. In some implementations, each corresponding device functionality may have corresponding “home” display objects displayed on the touch-sensitive display 1302, and the graphical user interface environment of FIG. 13A can be restored by pressing the “home” display object.

In some implementations, the top-level graphical user interface can include additional display objects 1306, such as a short messaging service (SMS) object 1330, a Calendar object 1332, a Photos object 1334, a Camera object 1336, a Calculator object 1338, a Stocks object 1340, a Address Book object 1342, a Media object 1344, a Web object 1346, a Video object 1348, a Settings object 1350, and a Notes object (not shown). Touching the SMS display object 1330 can, for example, invoke an SMS messaging environment and supporting functionality; likewise, each selection of a display object 1332, 1334, 1336, 1338, 1340, 1342, 1344, 1346, 1348, and 1350 can invoke a corresponding object environment and functionality.

Additional and/or different display objects can also be displayed in the graphical user interface of FIG. 13A. For example, if the device 1300 is functioning as a base station for other devices, one or more “connection” objects may appear in the graphical user interface to indicate the connection. In some implementations, the display objects 1306 can be configured by a user, e.g., a user may specify which display objects 1306 are displayed, and/or may download additional applications or other software that provides other functionalities and corresponding display objects.

In some implementations, the mobile device 1300 can include one or more input/output (I/O) devices and/or sensor devices. For example, a speaker 1360 and a microphone 1362 can be included to facilitate voice-enabled functionalities, such as phone and voice mail functions. In some implementations, an up/down button 1384 for volume control of the speaker 1360 and the microphone 1362 can be included. The mobile device 1300 can also include an on/off button 1382 for a ring indicator of incoming phone calls. In some implementations, a loud speaker 1364 can be included to facilitate hands-free voice functionalities, such as speaker phone functions. An audio jack 1366 can also be included for use of headphones and/or a microphone.

In some implementations, a proximity sensor 1368 can be included to facilitate the detection of the user positioning the mobile device 1300 proximate to the user's ear and, in response, to disengage the touch-sensitive display 1302 to prevent accidental function invocations. In some implementations, the touch-sensitive display 1302 can be turned off to conserve additional power when the mobile device 1300 is proximate to the user's ear.

Other sensors can also be used. For example, in some implementations, an ambient light sensor 1370 can be utilized to facilitate adjusting the brightness of the touch-sensitive display 1302. In some implementations, an accelerometer 1372 can be utilized to detect movement of the mobile device 1300, as indicated by the directional arrow 1374. Accordingly, display objects and/or media can be presented according to a detected orientation, e.g., portrait or landscape. In some implementations, the mobile device 1300 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 1300 or provided as a separate device that can be coupled to the mobile device 1300 through an interface (e.g., port device 1390) to provide access to location-based services.

In some implementations, a port device 1390, e.g., a Universal Serial Bus (USB) port, or a docking port, or some other wired port connection, can be included. The port device 1390 can, for example, be utilized to establish a wired connection to other computing devices, such as other communication devices 1300, network access devices, a personal computer, a printer, a display screen, or other processing devices capable of receiving and/or transmitting data. In some implementations, the port device 1390 allows the mobile device 1300 to synchronize with a host device using one or more protocols, such as, for example, the TCP/IP, HTTP, UDP and any other known protocol.

The mobile device 1300 can also include a camera lens and sensor 1380. In some implementations, the camera lens and sensor 1380 can be located on the back surface of the mobile device 1300. The camera can capture still images and/or video.

The mobile device 1300 can also include one or more wireless communication subsystems, such as an 802.11b/g communication device 1386, and/or a Bluetooth™ communication device 1388. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

FIG. 13B illustrates another example of configurable top-level graphical user interface of device 1300. The device 1300 can be configured to display a different set of display objects.

In some implementations, each of one or more system objects of device 1300 has a set of system object attributes associated with it; and one of the attributes determines whether a display object for the system object will be rendered in the top-level graphical user interface. This attribute can be set by the system automatically, or by a user through certain programs or system functionalities as described below. FIG. 13B shows an example of how the Notes object 1352 (not shown in FIG. 13A) is added to and the Web Video object 1316 is removed from the top graphical user interface of device 1300 (e.g. such as when the attributes of the Notes system object and the Web Video system object are modified).

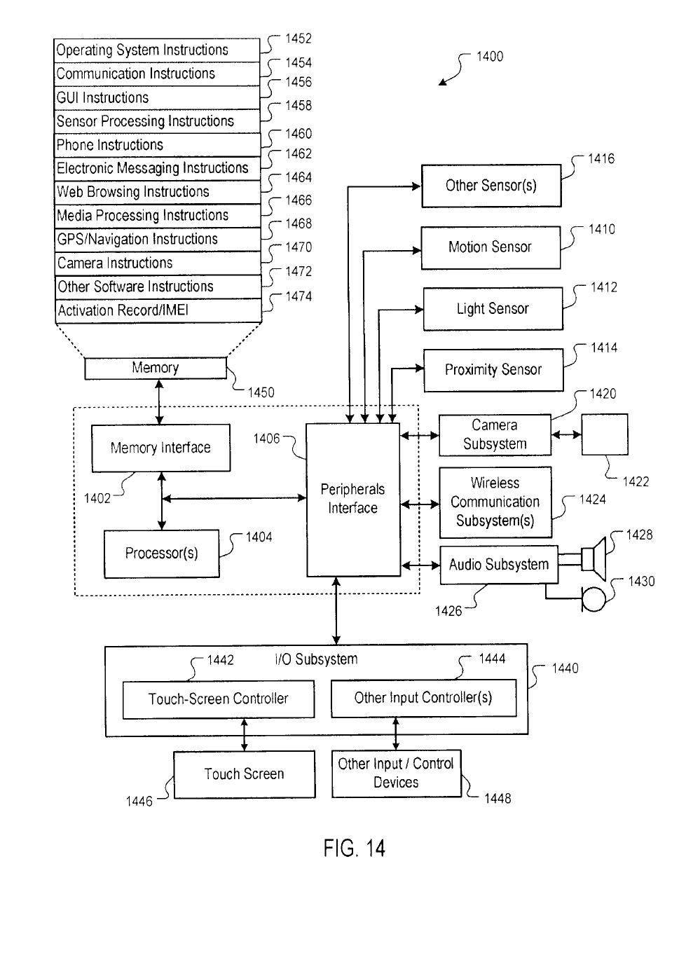

FIG. 14 is a block diagram 1400 of an example implementation of a mobile device (e.g., mobile device 1300). The mobile device can include a memory interface 1402, one or more data processors, image processors and/or central processing units 1404, and a peripherals interface 1406. The memory interface 1402, the one or more processors 1404 and/or the peripherals interface 1406 can be separate components or can be integrated in one or more integrated circuits. The various components in the mobile device can be coupled by one or more communication buses or signal lines.

Sensors, devices, and subsystems can be coupled to the peripherals interface 1406 to facilitate multiple functionalities. For example, a motion sensor 1410, a light sensor 1412, and a proximity sensor 1414 can be coupled to the peripherals interface 1406 to facilitate the orientation, lighting, and proximity functions described with respect to FIG. 13A. Other sensors 1416 can also be connected to the peripherals interface 1406, such as a positioning system (e.g., GPS receiver), a temperature sensor, a biometric sensor, or other sensing device, to facilitate related functionalities.

A camera subsystem 1420 and an optical sensor 1422, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 1424, which can include radio frequency receivers and transmitters and/or optical (e.g., infrared) receivers and transmitters. The specific design and implementation of the communication subsystem 1424 can depend on the communication network(s) over which the mobile device is intended to operate. For example, a mobile device can include communication subsystems 1424 designed to operate over a GSM network, a GPRS network, an EDGE network, a Wi-Fi or WiMax network, and a Bluetooth™ network. In particular, the wireless communication subsystems 1424 may include hosting protocols such that the mobile device may be configured as a base station for other wireless devices.

An audio subsystem 1426 can be coupled to a speaker 1428 and a microphone 1430 to facilitate voice-enabled functions, such as voice recognition, voice replication, digital recording, and telephony functions.

The I/O subsystem 1440 can include a touch screen controller 1442 and/or other input controller(s) 1444. The touch-screen controller 1442 can be coupled to a touch screen 1446. The touch screen 1446 and touch screen controller 1442 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 1446.

The other input controller(s) 1444 can be coupled to other input/control devices 1448, such as one or more buttons, rocker switches, thumb-wheel, infrared port, USB port, and/or a pointer device such as a stylus. The one or more buttons (not shown) can include an up/down button for volume control of the speaker 1428 and/or the microphone 1430.

In one implementation, a pressing of the button for a first duration may disengage a lock of the touch screen 1446; and a pressing of the button for a second duration that is longer than the first duration may turn power to the mobile device on or off. The user may be able to customize a functionality of one or more of the buttons. The touch screen 1446 can, for example, also be used to implement virtual or soft buttons and/or a keyboard.

In some implementations, the mobile device can present recorded audio and/or video files, such as MP3, AAC, and MPEG files. In some implementations, the mobile device can include the functionality of an MP3 player, such as an iPod™. The mobile device may, therefore, include a 32-pin connector that is compatible with the iPod™. Other input/output and control devices can also be used.

The memory interface 1402 can be coupled to memory 1450. The memory 1450 can include high-speed random access memory and/or non-volatile memory, such as one or more magnetic disk storage devices, one or more optical storage devices, and/or flash memory (e.g., NAND, NOR). The memory 1450 can store an operating system 1452, such as Darwin, RTXC, LINUX, UNIX, OS X, WINDOWS, or an embedded operating system such as VxWorks. The operating system 1452 may include instructions for handling basic system services and for performing hardware dependent tasks. In some implementations, the operating system 1452 can be a kernel (e.g., UNIX kernel).

The memory 1450 may also store communication instructions 1454 to facilitate communicating with one or more additional devices, one or more computers and/or one or more servers. The memory 1450 may include graphical user interface instructions 1456 to facilitate graphic user interface processing; sensor processing instructions 1458 to facilitate sensor-related processing and functions; phone instructions 1460 to facilitate phone-related processes and functions; electronic messaging instructions 1462 to facilitate electronic-messaging related processes and functions; web browsing instructions 1464 to facilitate web browsing-related processes and functions; media processing instructions 1466 to facilitate media processing-related processes and functions; GPS/Navigation instructions 1468 to facilitate GPS and navigation-related processes and instructions; camera instructions 1470 to facilitate camera-related processes and functions; and/or other software instructions 1472 to facilitate other processes and functions. The memory 1450 may also store other software instructions (not shown), such as web video instructions to facilitate web video-related processes and functions; and/or web shopping instructions to facilitate web shopping-related processes and functions. In some implementations, the media processing instructions 1466 are divided into audio processing instructions and video processing instructions to facilitate audio processing-related processes and functions and video processing-related processes and functions, respectively. An activation record and International Mobile Equipment Identity (IMEI) 1474 or similar hardware identifier can also be stored in memory 1450.

All of the methods and processes described above can be embodied in, and fully automated via, software code modules executed by one or more general purpose computers. The code modules can be stored in any type of computer-readable medium or other computer storage device. Some or all of the methods can alternately be embodied in specialized computer hardware.

Although this invention has been described in terms of certain embodiments and applications, other embodiments and applications that are apparent to those of ordinary skill in the art, including embodiments which do not provide all of the features and advantages set forth herein, are also within the scope of the invention. Accordingly, the scope of the present invention is intended to be defined only by reference to the following claims.

What is claimed is:

1. A method for providing a customized graphical interface comprising:
organizing, with an application, data to be presented as a plurality of hierarchical views;
generating a graphical interface to be displayed on an electronic device to display at least a subset of the data;
displaying the graphical user interface by the application calling at least one native application programming interface at runtime, wherein the at least one native application programming interface provides graphical navigation of the data through the hierarchical views in response to user input.

2. The method of claim 1, wherein the electronic device comprises a mobile wireless electronic device, the method further comprising:
detecting movement of the mobile wireless electronic device;
automatically indicating to the application, the movement of the mobile wireless electronic device; and
modifying the graphical user interface in response to the movement.

3. The method of claim 1 wherein a selected native application programming interface from the at least one native application programming interfaces an indication of the movement and causes the graphical user interface to be rotated in response to detected rotation of the mobile wireless electronic device.

4. The method of claim 1 wherein a selected native application programming interface from the at least one native application programming interfaces receives a text string from the application corresponding to a level in the hierarchy and causes the text string to be displayed within an element of the graphical interface that provides graphical navigation of the hierarchy.

5. The method of claim 1 wherein a selected native application programming interface from the at least one native application programming interfaces receives an image from the application corresponding to a level in the hierarchy and causes the image to be displayed within an element of the graphical interface that provides graphical navigation of the hierarchy.

6. The method of claim 5 wherein a selected native application programming interface from the at least one native application programming interfaces receives an image from the application corresponding to one of multiple categories of features within the application, each category of features having a hierarchy of views.

7. An apparatus to provide a customized graphical interface comprising:
means for organizing, with an application, data to be presented as a plurality of hierarchical views;
means for generating a graphical interface to be displayed on an electronic device to display at least a subset of the data;
means for displaying the graphical user interface by the application calling at least one native application programming interface at runtime, wherein the at least one native application programming interface provides graphical navigation of the data through the hierarchical views in response to user input.

8. The apparatus of claim 7, wherein the electronic device comprises a mobile wireless electronic device, the apparatus further comprising:
means for detecting movement of the mobile wireless electronic device;
means for automatically indicating to the application, the movement of the mobile wireless electronic device; and
means for modifying the graphical user interface in response to the movement.

9. An article comprising a computer-readable medium having stored thereon instructions for providing a customized graphical interface comprising, the instructions, when executed causing one or more processors to:
organize, with an application, data to be presented as a plurality of hierarchical views;
generate a graphical interface to be displayed on an electronic device to display at least a subset of the data;
display the graphical user interface by the application calling at least one native application programming interface at runtime, wherein the at least one native application programming interface provides graphical navigation of the data through the hierarchical views in response to user input.

10. The article of claim 9, wherein the electronic device comprises a mobile wireless electronic device, the instructions further comprising instructions that, when executed, cause the one or more processors to:
detect movement of the mobile wireless electronic device;
automatically indicate to the application, the movement of the mobile wireless electronic device; and
modify the graphical user interface in response to the movement.

11. The article of claim 9 wherein a selected native application programming interface from the at least one native application programming interfaces an indication of the movement and causes the graphical user interface to be rotated in response to detected rotation of the mobile wireless electronic device.

12. The article of claim 9 wherein a selected native application programming interface from the at least one native application programming interfaces receives a text string from the application corresponding to a level in the hierarchy and causes the text string to be displayed within an element of the graphical interface that provides graphical navigation of the hierarchy.

13. The article of claim 9 wherein a selected native application programming interface from the at least one native application programming interfaces receives an image from the application corresponding to a level in the hierarchy and causes the image to be displayed within an element of the graphical interface that provides graphical navigation of the hierarchy.

14. The article of claim 9 wherein a selected native application programming interface from the at least one native application programming interfaces receives an image from the application corresponding to one of multiple categories of features within the application, each category of features having a hierarchy of views.

15. The article of claim 9 wherein the native application programming interfaces comprise a set of header files to be included in the application.

16. A system comprising:
a processor;
a memory coupled with the processor;
a third-party software module to manage and present data on the system as a plurality of hierarchical views and to generate a graphical interface to be displayed on the system to display at least a subset of the data;
an API runtime module linked to the third-party software module, the API runtime module to provide native graphical navigation elements to be utilized by the third-party software module to display the graphical interface on the system.

17. The system of claim 16 wherein the API runtime module further detects movement of the system, automatically indicates to the third-party software module, the movement of the system, and modifies the graphical user interface in response to the movement.

18. The system of claim 16 wherein the API runtime module receives a text string from the third-party software module corresponding to a level in the hierarchy and causes the text string to be displayed within an element of the graphical interface that provides graphical navigation of the hierarchy.

19. The system of claim 16 wherein the API runtime module receives an image from the third-party software module corresponding to a level in the hierarchy and causes the image to be displayed within an element of the graphical interface that provides graphical navigation of the hierarchy.

20. The system of claim 16 wherein the API runtime module receives a call from the third-party software module to access data in another application also utilizing the API runtime module and returns the data to the third-party software module via the API runtime module.
